(19) United States
(12) Patent Application Publication
(10) Pub. No.: US 2010/0180330 A1
(43) Pub. Date: Jul. 15, 2010

(54) Securing Communications for Web Mashups

(75) Inventors: Bin Zhu, Edina, MN (US); Min Feng, Chengdu (CN); Rui Guo, Beijing (CN)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/351,198

(22) Filed: Jan. 9, 2009

(51) Int. Cl. H04L 9/32; G06F 21/00

(52) U.S. Cl. 726/10

(57) ABSTRACT

Techniques described herein provide security for communications in web mashups. Some implementations secure web mashups by specifying and monitoring a lifecycle of one or more web applications that communicate with each other through implementation of lifecycle declarations. Furthermore, some implementations herein may use access tickets to provide access control between web applications in a web mashup.

### BACKGROUND

There has recently been an explosive growth in the use of web mashup applications on the World Wide Web (WWW or the Web). Typically, a web mashup aggregates and integrates content from multiple sources on the Web to create a new web experience at a single website. For instance, Web 2.0 applications may use the client-side browser as a new platform and integrate multiple web APIs (Application Program Interfaces) to create web mashups. An example of a web mashup is a website which, for instance, overlays real estate information provided by a first website on maps provided by a second website to allow users to visually navigate and filter real estate information for a given location. Other mashup examples include personally customized portal pages such as iGoogle™ and Windows Live™, where web components from different sources can be aggregated, presented, and even collaborate in a consistent view. It has been predicted that by 2010 web mashups will be dominant for the creation of new enterprise applications on the Web.

However, the origin-based trust model adopted by the current WWW standards was not designed to handle security for web mashups, in which secure communications among applications and services from different domains are necessary. The origin-based trust model was adopted by the current WWW standards defined in 1996, and is a binary trust model which defines that documents from different origins are not trusted and cannot affect each other, while documents from the same origin are trusted and allowed to interact without constraints. This model is not able to support web mashups since (1) web components in a web mashup have partial trust relationships and need to be able to communicate with each other in a controlled manner; and (2) origin is no longer appropriate for use as a security boundary in today's web applications. For example, it is possible that mutually untrusted web components might be placed in the same domain, e.g., at a public web hosting service site, while mutually trusted, or even the same, web applications may reside in multiple domains. For example, the Gmail™ service can presently be accessed from both “gmail.com” and “google.com/mail” domains.

Newly proposed secure cross-domain communication (SCDC) schemes require upgrading the existing WWW standards to support a new way for performing cross-domain communications. In particular, several new SCDC schemes have been proposed that allow controlled cross-domain communications for web mashups. Some such recently proposed SCDC schemes include HTML5 (HyperText Markup Language 5), MashupOS, and CompoWeb. HTML5 is a new version of HTML being developed by, among others, the W3C® HTML Working Group. MashupOS is a system developed by Microsoft Corporation of Redmond, Wash., to isolate mutually untrusting web services within a browser, while allowing communications there between. CompoWeb is a component-oriented web architecture also developed by Microsoft Corporation of Redmond, Wash. These newly proposed schemes are able to provide secure cross-domain communications for static web mashups. A static web mashup is a mashup in which child web components do not load different web applications at different times. However, none of these schemes has fully resolved the secure cross-domain communication problem for web mashups. For example, while some of these proposals work well for static web mashups, there are vulnerabilities when these proposals are applied to a dynamic web mashup where a web component loads different web applications at different times. Thus, the proposed schemes are still vulnerable to more complex attacks such as cross-web-component phishing (CWCP) attacks in which a malicious web application attempts to acquire sensitive information by masquerading as a trustworthy web application in a dynamic web mashup.

Furthermore, access control is crucial to interactions between two partially trusted peers. The inventors have determined that web infrastructure should enable each communication peer to decide whether to provide services to another peer based on the identity of the other peer and when such services should be terminated. Several SCDC schemes allow a web application to check the origin of a web component that the application interacts with every time when an interaction occurs. For example, in HTML5, the message sender can assert the origin of the receiver by giving an optional argument to the postMessage function. The posted message will be automatically abandoned if the origin of the receiver does not match the optional argument. The message receiver in HTML5 can also identify the origin of the message sender by checking the argument of the receive message event handler. Thus, to prevent a cross-web component phishing attack in HTML5 it is necessary to verify the sender's domain every time that a credential message is sent out. The shortcomings in HTML5 in having to identify a communication peer by checking the peer's origin every time include: (1) In HTML5 it is optional to verify the receiver's domain, and in many cases a web developer would omit this option for convenience; (2) “origin”, as discussed above, is no longer suitable to be considered as a security boundary in today's web applications; and (3) to repeat the same identification logic every time that an interaction occurs is inefficient and unnecessary.

### SUMMARY

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

Implementations disclosed herein may specify and monitor a lifecycle of each web application and may use access tickets to offer a fine-grained and efficient access control to address vulnerabilities in communications between peer applications. Some implementations also describe how to apply features to existing communication schemes to thwart attacks that may take place during communications between two applications in a web mashup.

### BRIEF DESCRIPTION OF THE DRAWINGS

The accompanying drawing figures, in conjunction with the general description given above, and the detailed description given below, serve to illustrate and explain the principles of the best mode presently contemplated. In the figures, the left-most digit of a reference number identifies the figure in which the reference number first appears. In the drawings, like numerals describe substantially similar features and components throughout the several views.

FIG. 1 depicts an illustrative architecture in which some implementations may be applied.

FIG. 2A depicts a logical and hardware arrangement in accordance with the architecture of FIG. 1.

FIG. 2B depicts a flowchart of an exemplary process according to some implementations.

FIG. 3 depicts a conceptual diagram of web application access according to some implementations.

FIG. 4 depicts a flowchart representing an exemplary process according to some implementations.

FIGS. 5A and 5B depict an exemplary implementation applied in a CompoWeb environment.

### DETAILED DESCRIPTION

In the following detailed description, reference is made to the accompanying drawings which form a part of the disclosure, and in which are shown by way of illustration, and not of limitation, exemplary implementations. Further, it should be noted that while the description provides various exemplary implementations, as described below and as illustrated in the drawings, this disclosure is not limited to the implementations described and illustrated herein, but can extend to other implementations, as would be known or as would become known to those skilled in the art. Reference in the specification to “implementations”, “this implementation”, “these implementations” or “some implementations” means that a particular feature, structure, or characteristic described in connection with the implementations is included in at least one implementation, and the appearances of these phrases in various places in the specification are not necessarily all referring to the same implementation. Additionally, in the description, numerous specific details are set forth in order to provide a thorough disclosure. However, it will be apparent to one of ordinary skill in the art that these specific details may not all be needed in all implementations. In other circumstances, well-known structures, materials, circuits, processes and interfaces have not been described in detail, and/or may be illustrated in block diagram form, so as to not unnecessarily obscure the disclosure.

Terminology used in this document will next be described and defined.

Web Application: A web application describes the web content which provides some service and which is able to be aggregated into one or multiple web mashups. A web application typically manifests as an HTML document and is represented by the Document Object Model (DOM). A web application has its own origin properties, such as domain and URL (Uniform Resource Locator).

Web Components: The Web component is used to describe the container of a web application. A Web component is an HTML element which makes it possible to embed a web application inside another web application. A web component is commonly defined by <iframe> and <object>. In some SCDC schemes, new HTML tags are also used to define web components, such as <friv> in MashupOS and <gadget> in CompoWeb. A web application aggregated into web mashups typically does not have its own name. In such a case, the web application can be referenced by the name of the web component upon which the web application resides. A web component may load sequentially different web applications which provide different services in the mashup in a dynamic manner.

Binary Trust Model: The binary trust model, either no trust or full trust, is used by today's WWW standards and browsers, governed by the Same Origin Policy (SOP) which provides that contents from different origins cannot interact with each other, while contents from the same origin can read and write each other's full state without constraints. Two web contents have the same origin if and only if their domain names, protocols, and ports are all the same. Since most web applications are built on the HTTP Protocol with default port 80, the origins of two web contents manifest mainly in their domains. For easy discussion in this disclosure, origin and domain are used interchangeably in the rest of this disclosure. Each browser window, such as an <iframe>, contains a separate document, and the document is associated with an origin. Note that scripts enclosed by <script> in a document are treated as libraries that can be downloaded from different origins, run as the document's origin rather than the origins from which they are downloaded, and therefore always have full access to the host document. Conventional web mashups are restricted by SOP, which makes it difficult to allow web components from different origins to perform secure client-side communications. Several schemes have been proposed to enable more secure cross-domain communications (SCDC) without modifying the current WWW standards. Some such schemes use fragment identifiers to enable cross-domain communications under the current WWW standards. Typically, a fragment identifier refers to a resource that is subordinate to a primary resource. For example, a fragment identifier may be appended to the URL of a hypertext document for identifying a particular portion of that document. The proposed schemes use fragment identifiers to verify the source of a message. The shortcomings of the “fragment identifier” proposals include: (1) a web frame needs to actively and periodically check its URL to receive a message; (2) the message length is restricted by the maximum URL length that a browser allows; and (3) the message receiver cannot identify the message sender, which may be exploited in an attack. Therefore the “fragment identifier” proposals are still far away from a perfect solution.

Partial Trust Model: Two web applications from mutually unknown origins should maintain a partial trust relationship when they interact with each other in a web mashup. The inventors have determined that a desired environment for web mashups is: (1) the DOM tree and JavaScript® context of each application are isolated from others by default; and (2) inter-component communications are secure—malicious components (including a malicious aggregator) can not affect the integrity and confidentiality of the communications between two other components, although denial-of-service attacks resulting in aborted connections could be unavoidable. The partial trust model demands an access control finer than that provided by the binary trust model. Therefore the binary trust model cannot support web mashups well, and the partial trust model according to implementations herein is better able to support web mashups.

Secure Cross-Domain Communications (SCDC): Several proposals have been suggested to enable secure cross-domain communications. These proposals provide various mechanisms to support controlled interactions between web applications in a web mashup, where a controlled interaction means: (1) either only pure data is exchanged by web applications, or only those functionalities that are explicitly exposed by a web application can be accessed by other applications; and (2) during an interaction each communication peer runs its logic in its own context, therefore its private states and data are protected. At least in a static web mashup, the controlled interaction schemes make aggregated web applications from different origins able to collaborate in a secure way. In HTML5 and MashupOS, each web application is able to verify the identity of its communication peer by checking the peer's origin. The name of the web component in which a web application resides is used to reference the web application in all these SCDC schemes.

Cross-Web Component Phishing: Phishing is a common attack in today's Web. Phishing attacks attempt to acquire sensitive information such as usernames, passwords, credit card numbers, or the like by masquerading as a trustworthy entity in an electronic communication. Traditional phishing attacks usually happen between a browser user and a malicious web site. In web mashups, however, similar attacks can occur between two web components interacting with each other. For example, an attacker can try to make a web component silently unload a trustworthy web application and then load a malicious one, with the confidential information supposed to be received by the unloaded trustworthy application intercepted by the loaded malicious application. In this example, suppose a malicious aggregator M loads a pair of mutually trusted web applications A and B, then intercepts the secret information supposed to be shared only between A and B by replacing A with a malicious web application N. For instance, B might be a confidential information publisher that sends confidential information periodically to only the authenticated users. In this attack, A provides its credentials to B, and after verifying A's credentials, B periodically sends confidential information to A. If A and B are loaded by a malicious aggregator M, malicious aggregator M could instruct A's HTML frame to load the malicious web application N by directly setting A's location property. According to current standards and HTML5, B will not be notified that A has been replaced by N. As a result, B continues sending confidential information to A, and the confidential information is in fact received by N. These types of phishing-like attacks that can take place between web components in a web mashup are referred to as Cross-Web Component Phishing (CWCP) attacks.

Static and Dynamic Web Mashups: Web mashup applications integrate content from multiple other sources on the WWW to create new web experiences. In some implementations, a mashup application accesses third party services and/or data independently using an API, or the like, for processing the services and/or data in some way to add value, although this disclosure is not limited to any particular type of mashup application. A static web mashup is a mashup in which child web components do not load different web applications or resources at different times. In a dynamic web mashup, on the other hand, a web component may load different web applications or resources at different times for various reasons.

### Overview

Implementations described herein enable each communication peer in a web mashup to decide whether to provide services to another peer, and to further decide when such services should be terminated. In some implementations, a service-providing application in a web mashup issues an access ticket to a service-consuming application to specify functionalities that may be accessed by the service-consuming application. Additionally, in some implementations, an application participating in the mashup can specify a lifecycle that is monitored by a browser, and communication between the applications is terminated when the lifecycle of one or more of the applications expires. In some implementations, each web application can explicitly declare its lifecycle to the web browser. In some implementations, each web application can explicitly declare its lifecycle specifically for an interaction with another web application, and this lifecycle can be different for interactions with different web applications. In some configurations, a web browser guarantees that interactions between two web applications terminate when either web application's lifecycle ends, and the web browser may inform the other web application that the lifecycle has expired. In some implementations, an access ticket from the web application which provides the service must be acquired in order for a web application to access the service-providing web application's exposed functionalities. In some implementations, a service-providing web application can specify its lifecycle for each access ticket it issues, and the lifecycles for different access tickets can be different. In some implementations, a web browser may guarantee that all access tickets issued by a web application would expire when the expiration condition is met. In some implementations, having an access ticket allows a web application to access the functionalities specified by the access ticket without any further checking by the ticket-issuing web application, resulting in more efficient access control than checking for every access, such as in HTML5. In some implementations, an access ticket is bound to the ticket requester, and only the requester is able to use the ticket to access the web application's exposed functionalities. The ticket can neither be transferred to another web application, nor generated by the requesting web application itself. In some implementations, when a web application responds to an access ticket request, the web application can select a subset of its own exposed functionalities for the requester to access through the acquired access ticket. Accordingly, implementations are able to provide access control based on a web application's lifecycle and based on access tickets that identify particular functionalities of a web component that another web component is able to access using the access ticket, which can effectively thwart complex attacks that exploit the dynamic nature of web components, such as cross-web component phishing attacks. Thus, implementations provide fine-grained and efficient access control for web components.

### Exemplary Architecture

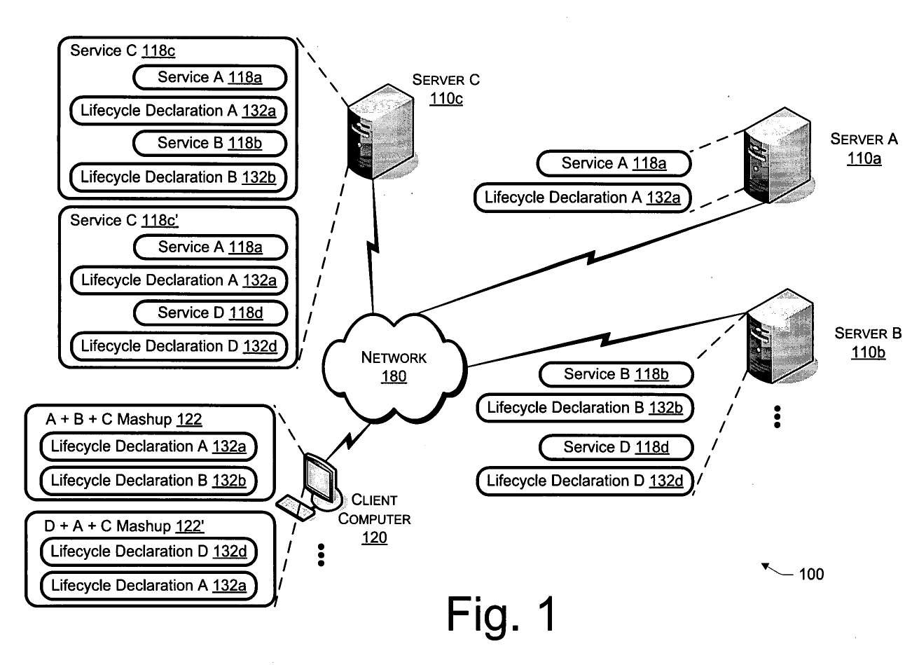

Implementations described herein include a lifecycle declaration and access tickets for efficient and fine-grained access control. FIG. 1 depicts an illustrative architecture of a system 100 that may employ the described techniques. The architecture of FIG. 1 includes one or more servers 110, with servers 110a-110c being illustrated in this exemplary implementation. Further, one or more client computers 120 may be included, and a network 180 may be provided for enabling communication among servers 110a-110c and client computers 120. Network 180 may be a local area network (LAN), wide area network (WAN), such as the Internet, or other suitable network including wired and wireless networks, or any combination thereof. In some implementations, network 180 operates using HTTP (Hypertext Transfer Protocol), although other implementations may use alternative protocols.

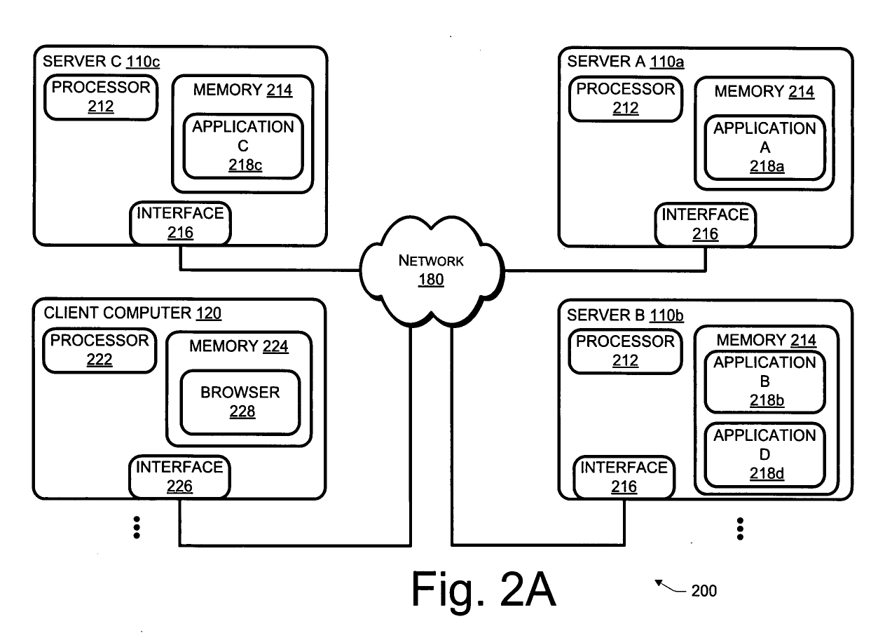

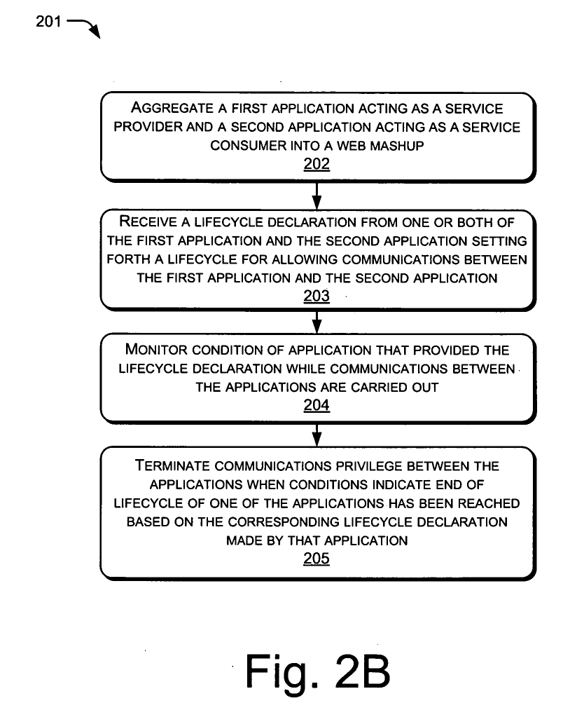

FIG. 2A illustrates a logical and hardware arrangement of a system 200 corresponding to the implementation of FIG. 1. In FIG. 2A, each application server 110 includes a processor 212, a memory 214 and an interface 216 for enabling communication over network 180. Further, client computers 120 include a processor 222, a memory 224 and an interface 226 for enabling communication over network 180. Memories 214, 224 may include volatile or nonvolatile random access memory, storage devices, such as disk drives, solid-state drives, removable storage media, other processor-accessible storage media, or the like. Servers 110 and client computers 120 may also include a number of additional components and software modules, as known in the art, such as operating systems, communication modules, displays, user interfaces, peripherals, and the like, that are not illustrated for clarity of explanation.

Each server 110 may include one or more applications 218 stored in memory 214 and executable by processor 212. Further, each client computer 120 may include a web browser 228. In some implementations, applications 218 may be web applications that provide a service that can be accessed by client computers 120 and/or other servers 110. For example, client computer 120 may use browser 228 to access an application C 218c on server 110c, such as for displaying a web page at client computer 120.

In the illustrated example, application C 218c on server 110c may be a mashup application that provides a service C 118c which uses a service A 118a provided by application A 218a on server 110a and which also uses a service B 118b provided by application B 218b on server 110b to provide service C 118c as a web mashup 122 to browser 228 on client computer 120. During the mashup, application A and/or application B may exchange information with each other, with application C, and/or with client computer 120.

In this example, the mashup 122 may be considered static if only applications A and B are used during the mashup. However, if one of the applications A or B changes it's URL, performs a refresh, or performs an action to retrieve content dynamically from other locations, or if application D 218d, providing a service D 118d, is later included in the mashup, as illustrated by service C 118c′, either in place of another application, such as application B 218b, or in addition to another application, then the resulting mashup 122′ may be considered to be a dynamic mashup. For example, the mashup service C 118c might initially provide a mashup incorporating services A, B and C to client computer 120 as mashup 122. At a later point in time, the mashup service C 118c′ might provide a mashup 122′ incorporating services D, A and C to client computer 120. Thus, in this example, Application C on server C 110c can be considered as an aggregator or a container application, while application A 218a, application B 218b and application D 218d can be considered as children of aggregator C. These applications can be service providers or service consumers. Further, while FIGS. 1 and 2 describe an example of a mashup in the context of a client-side architecture, it should be noted that other implementations are not limited to these particular implementations, but also encompass other types of mashups and the provision of integrated web services. Mashups can themselves be incorporated into other mashups or services.

A feature that can be exploited by a CWCP attack is that a web application is usually referred to by the name of the web component upon which the web application resides. This method can typically provide security in the case of static web mashups where a web component is associated with only one web application. However, in a dynamic web mashup, a web component may be associated sequentially with several web applications. A web component may load different web applications at different times for various reasons, such as page navigation or script execution. When a web application is acting as an aggregator or even as a child web application, the web application may unload an old web application and then load a new web application in the same web component, and if the communication peers of the old web application fail to be aware of the change in the web component of the old web application, then these peers may continue to send messages to the same web component which is now associated with the newly loaded web application, and possibly be exploited by malicious users to perform phishing or eavesdropping attacks. Using the origin to identify a web application may not be suitable, as was pointed out above.

Implementations described herein use a lifecycle declaration and monitoring, and/or access tickets for securing dynamic mashups. Thus, each web application may be able to declare its own lifecycle, and the lifecycle of each web application may be monitored by the browser to notify the other web applications that are communication peers of the web application whose lifecycle has expired. This lifecycle can be global, i.e., all the services a web application provides to other web applications terminate when the expiration condition is met; or the lifecycle can be individual, i.e., the lifecycle can be specified for a service to a specific web application, and services to different web services may expire at different times. When the expiration condition is met, the browser notifies the affected web applications. These applications will thereby be made aware of the expiration of the interactions. Also, mechanisms may be incorporated to ensure that the interaction between two web applications is automatically terminated if either of the two web applications expires. Further, implementations herein provide for an efficient access control scheme in which access tickets must be acquired in order to access a web component's exposed functionalities, thereby enabling each peer to decide whether to provide services to another peer based on the identity of the peer, and to also decide which particular functionalities will be provided as the services. Only the exposed functionalities contained in the access ticket can be accessed by the ticket holder. An expiration condition specific for the access ticket can be specified by the issuing web application, and this expiration condition can be different from that for another access ticket the web application issues.

### Lifecycle Declaration

The lifecycle of a particular web application, when used in a web mashup, may be defined as the time span during which the web application provides a constant set of functionalities. A web application is said to have expired when the web application's lifecycle ends, e.g., the web application is no longer providing the constant set of functionalities. In addition to this global lifecycle for a web application, i.e., all the services it provides to other web applications terminate when the service providing web application's lifecycle ends, a web application can also specify its lifecycle for the service it provides for a specific web application. In the latter case, a web application has different lifecycles for different services it provides to different web applications.

As discussed above, it is not reliable to determine whether a web application's lifecycle has expired by merely checking whether the origin of the web application has changed. Due to the dynamic nature of some mashups and the WWW, a web application may expire for many reasons. There is no simple and universal rule that can be relied on to automatically detect the expiration of a web application. However, the inventors have identified that web application lifecycles can be classified into a few major lifecycle patterns, and a web application developer should be able to explicitly declare the lifecycle pattern of a particular application, which would tell a browser how to decide if the particular web application has expired or not.

From the client-side point of view, the inventors have identified three instances or rules by which it may be determined that a web application's lifecycle is complete, as follows:

(1) Page Location Rule (i.e., navigating to another URL): In the WWW, the URL is used to globally identify a resource. A complete URL can take the following form:

“protocol://domain/path#fragment_identifier?query_strings”,

where “fragment_identifier” represents or specifies a fragment or particular portion of a web page maintained at the URL, and “query_strings” contain a set of parameters used to express a query to the web page. All these parts in a URL except the fragment identifier are able to affect a web application's lifecycle, i.e., modification to any parts in a URL other than the fragment identifier can be used to conclude that a lifecycle of a web application has expired. Modification of just the fragment identifier, however, is not necessarily an accurate indication that a lifecycle has expired because another portion or fragment of the same web page may be referred to without indicating expiration.

(2) Page Refresh Rule: A web server may retrieve different content when a web page is refreshed. Therefore a page refresh could result in expiration of a web application, and can be used as an indicator that a lifecycle has expired.

(3) Script Running Rule: JavaScript® is powerful enough to define new logic and modify a page through the HTML DOM API. In addition, many of today's web applications use AJAX (Asynchronous JavaScript® and XML) technology to retrieve content dynamically from remote servers without refreshing or navigating away from the web page. Accordingly, the running of script, such as JavaScript®, AJAX, or the like can be used to indicate that a lifecycle has expired.

In implementations described herein, a web application developer can use one or more of the above three types of rules to declare the lifecycle of a web application. The page location rule helps check whether the page URL of a web application follows a specified pattern or whether any part of the page URL has changed. The page refresh rule helps check whether the particular application page has been refreshed. The script running rule helps check whether a certain script function has been executed in the application's context.

In some implementations, by describing the lifecycle of a web application using these three types of rules or patterns, web developers are able to specify the lifecycle of a web application written with various server-side technologies. In some implementations, the lifecycle can be specified in XML. For example, assume that service A 118a is a static page with URL “http://somesite/getapp?id=100”, where “static page” means that the content of the page does not change unless it is navigated to another URL. Then, A's author can use the following to describe A's lifecycle: The page URL is http://somesite/getapp, and the value of the page parameter named “id” does change. An example of corresponding XML for declaring the lifecycle might be as follows:

<lifecycle Declaration >
<condition type=“inUrl” arg=“http://somesite/getapp” />
<condition type=“pageParameterUnchanged” arg=“id” />
</lifecycle Declaration >

As another example, suppose that service B 118b is a web page that can download new content using Ajax technology and replaces the original content without refreshing or navigating from the page. In this situation, the page author can define a void script function, having a name such as “onLoadNewContent”, and call the function every time that the page's content has changed. Then B's author can describe B's lifecycle as follows: the script function named “onLoadNewContent” is not executed, and an example of the corresponding XML might be as follows:

<lifecycleDeclaration >
<condition type=“untilScript” arg=“onLoadNewContent” />
</lifecycleDeclaration >

Similar script might be used to declare a lifecycle that terminates when a page is refreshed. Thus, in comparison with previous methods of declaring an application's domain, the implementations set forth herein provide for a lifecycle declaration that may be provided by a web application when the web application is engaged in a mashup. The lifecycle declaration enables a browser to monitor the lifecycles of web applications much more precisely, and terminate a particular application's access privileges when a life cycle has been determined to have ended, as judged using the rules set forth above. Further, while examples of lifecycle declarations have been set forth in XML format, other suitable formats and structures for lifecycle declarations may also be used in other implementations.

In some implementations, as illustrated in FIGS. 1 and 2A, each web application, such as web applications A, B and D, 218a, 218b and 218d, respectively, may be coded to provide a lifecycle declaration 132a, 132b and 132d, respectively, that sets forth a lifecycle according to one or more of the three rules discussed above during the initial identification process. These lifecycle declarations 132a, 132b, 132d may be received by the browser 228 at client computer 120 and monitored by browser 228. In some implementations, browser 228 can be configured to terminate a particular application's access privileges when a lifecycle of the application has been determined to have ended. Further, when a web application is dynamically added, such as when service D is added to mashup 122′, the lifecycle declaration 132d for the corresponding application D 218d can also be monitored by browser 228.

A web application can also declare its lifecycle for an interaction with a specific web application in a similar manner at the time the interaction is established. This lifecycle can be different for interactions with different web applications. The browser 228 will monitor the lifecycle for this specific interaction and notifies the affected party when the lifecycle of either one of the two parties in the interaction ends.

FIG. 2B sets forth a flowchart 201 of an exemplary process that may be carried out in light of the implementations of FIGS. 1 and 2A. In some implementations, the process is carried out by the browser 228 receiving the web mashup 122. The process may involve the web application aggregating the web mashup, e.g., application C 218c, and the applications 218a, 218b, 218d aggregated into the web mashup.

Step 202: A first application providing a service and a second application consuming the service are aggregated into a web mashup in which the first application and the second application should have secure communications between each other, such as for guarding against CWCP attacks or other security concerns.

Step 203: One or both of the first application and the second application makes a lifecycle declaration setting forth a lifecycle during which communications between the first application and the second application may be considered to be secure. In some implementations, only one application might make a lifecycle declaration, while in other implementations, both applications may make a lifecycle declaration, depending on the nature of the communications between the applications and which of the applications might be disclosing confidential information or otherwise be vulnerable to attack.

Step 204: The condition of the application(s) that provided the lifecycle declaration is monitored while communications between the applications are carried out. In some implementations, the browser 228 on the client side may monitor the lifecycle of each of the applications that made the lifecycle declaration.

Step 205: When the lifecycle of an application that made a lifecycle declaration is determined to have reached an endpoint, the communications privilege between the applications may be terminated. Thus, when conditions indicate the end of the lifecycle of one of the applications based on the corresponding lifecycle declaration made by that application, then the communications between the applications are no longer considered to be secure. In some implementations, the browser may notify the other application that lifecycle has ended and the communications are no longer secure.

A web application can be a service provider as well as a service consumer. For example, the second application in FIG. 2B can provide a second service for the first web application to consume while also consuming the first service provided by the first web application. In this case, the communication that the first web application provides the first service to the second web application is considered separated from the communication that the first web application consumes the second service provided by the second web application.

### Access Tickets

Implementations provide for the use of “access tickets” to describe the accessibility to functionalities exposed by a web application. An access ticket must be acquired from a first web application which provides a service before a second web application can access the service provided by the first web application. An access ticket may be granted by the first application to the second application to access all the functionalities exposed by the first application, or the access ticket granted to the second application may enable the second application to access to only particularly specified one or more functionalities out of a total number of exposed functionalities of the first application. In some implementations, the access tickets are implemented in conjunction with the lifecycle declarations discussed above. A web application can declare its lifecycle globally for all the access tickets that it issues or specifically for a specific access ticket that it issues. In the latter case, different access tickets that a service providing web application issues may have different conditions by which its lifecycle ends for different access tickets, i.e., different web applications. In some implementations, the ticket requester may not need to declare or use its lifecycle since the requester can simply destroy or not use the ticket when its lifecycle for a specific communication with a service provider ends. As described further below, an access ticket cannot be transferred from one web application to another or generated by a requesting web application. An access ticket can only be generated by a service providing web application for other web applications to access its service. In other implementations, the lifecycle declarations and the access tickets are implemented independently of each other.

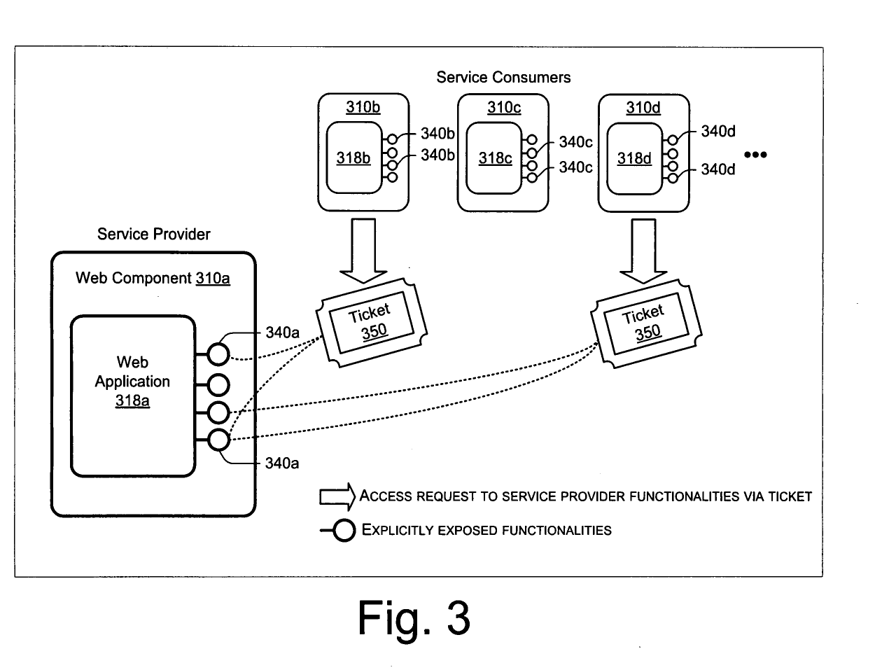

In an exemplary implementation, as illustrated in FIG. 3, a web mashup consists of a plurality of web components 310. Each web component 310 is capable of containing one or more web applications 318 having one or more functionalities 340 such as methods, properties, and/or events that are exposed for access by other web applications 318, with each web component 310 typically only containing one web application at a time, but possibly containing different web applications at different times. For example, as illustrated in FIG. 3, web component 310a includes a web application 318a having a plurality of functionalities 340a that are explicitly exposed for interaction with other web components. Web application 318a is able to determine which of these functionalities 340a may be accessed by which other web applications 310b-310d by requiring the other web applications 310b-310d wishing to access the functionalities 340a of web application 318a to first obtain an access ticket 350 and use this access ticket 350 to access the functionalities 340. Similarly, some or all of the other web applications 318b-318d may also have exposed functionalities 340b-340d, respectively, that may be accessed by the other web applications 318, and, in some implementations, may also serve as service providers instead of or in addition to being service consumers.

In some implementations, an access ticket is a native object created by a browser. A native object is an object whose internal logic and status are protected by a browser from being accessed by JavaScript® used in web applications. Modern browsers provide mechanisms to allow a native object to expose some of its functionalities to JavaScript® to access and manipulate. For example, Internet Explorer® supports interoperations between JavaScript® objects and COM (Component Object Model) objects, and Mozilla® provides an XPConnect (Cross-Platform Connect) mechanism to enable interoperations between JavaScript® objects and XPCOM (Cross-Platform Component Object Model) objects. Some functionalities of a native object may not be accessed or manipulated by JavaScript®. For example, JavaScript® cannot directly create a host object (for example by using the “new” keyword to create an object). In implementations herein, copying an access ticket by the service consumer holding the access ticket is disabled by the browser. Since JavaScript® cannot create a native object directly, when a first web application issues an access ticket to a service requester, the first application passes parameters to the browser to create a native object as the access ticket for other web applications to access the exposed functionalities of the first web application. The first web application can ask the browser to create access tickets for other applications to access the exposed functionalities of the first web application. However, the first web application cannot let the browser create an access ticket to access other web application's exposed functionalities. In creating an access ticket, a web application can optionally specify its lifecycle specifically for the ticket and pass the information to the browser via the API. Otherwise, the global lifecycle declared by the web application is also used for the access ticket.

When an exposed functionality is allowed to be accessed via an access ticket, the functionality is referenced in the native object of the access ticket, and browser supports that this referenced functionality can be accessed and manipulated by JavaScript®. The ticket holding web application can invoke with JavaScript® the referenced functionality via the native object of the access ticket. The access ticket will then delegate the invocation to the service providing web application. Only those functionalities referenced in the access ticket can be accessed by the ticket holder. Those functionalities not referenced in the access ticket cannot be accessed by the ticket holder. In this way, the ticket issuing web application can select which exposed functionalities are able to be accessed by a service consumer. If a first web application, as a service consumer, has a valid access ticket and that ticket references a functionality of a second web application that issued the access ticket as a service provider, then the first web application can access that functionality of the second web application; otherwise if the first web application does not have a valid access ticket for accessing services of the second application, or if the first application does not have an access ticket that enables access to the particular functionality, then the first web application cannot access the particular functionality of the second application. In this way, the service providing web application does not check whether or not a service consuming web application has the right to access its exposed functionalities when the exposed functionalities are accessed. This implementation is very different from HTML5 in which the origin has to be checked every time a message is communicated. Thus, the implementations herein providing access via an access ticket are much more efficient.

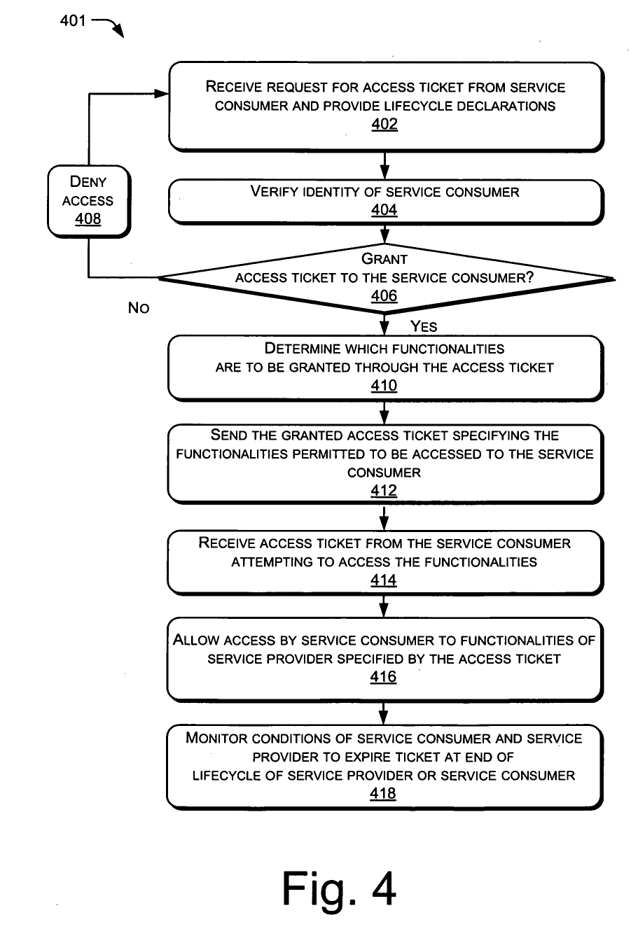

For example, web components 310a-310d may be servers in some implementations, such as servers 110 connected via network 180, as discussed above with respect to FIGS. 1 and 2A. For example, in some implementations of the architecture of FIGS. 1 and 2A, application A 218a may correspond to service provider web application 318a and application B 218b may correspond to service consumer web application 318b. Thus, when mashup 122 is initialized, communication may be established and secured between application A 218a and application B 218b according the techniques described with reference to FIGS. 3-4. Further, in some implementations, some of web components 310 may be on the same servers, computers, access devices, or the like, or some or all of web components 310 may be on different such devices.

In implementations of the ticket-based communication technique described herein, web applications 318 are not allowed to directly access each other's exposed functionalities 340. Instead, as illustrated in FIG. 4, interaction flow between two web applications 318 may use the exemplary steps set forth below and as depicted in flowchart 401. Furthermore, FIG. 4 also includes implementations which comprise the lifecycle declarations discussed above.

Step 402: A service provider, e.g., web application 318a, receives a request for an access ticket from a service consumer, e.g., web application 318b, and the service provider and/or service consumer provide lifecycle declarations to the browser, as discussed above.

Step 404: The service provider, e.g., web application 318a, verifies the identity of service consumer 318b. This is carried out by verifying the origin, the GUID (Globally Unique Identifier), the URL of the service consumer 318b or the authentication credentials provided by the service consumer 318b.

Step 406: The service provider, web application 318a, then decides whether to grant an access ticket or not. Access control rules may be consulted by web application 318a for determining whether a particular service consumer 318b-318d should have access to particular functionalities 340a. These access control rules may be tailored for each service provider and for specific service consumers.

Step 408: If the identity of the service consumer cannot be sufficiently verified, or if the service provider determines not to grant the access request for some other reason, then the access request is denied.

Step 410: If a ticket is granted, the service provider can determine and specify in the ticket which of its supported functionalities will be able to be accessed by the service consumer using the access ticket. When the service provider application issues an access ticket to a service consumer/requester, the service provider passes parameters to the browser to create a native object as the access ticket for enabling the service consumer to access the exposed functionalities of the service provider. Thus, in these implementations, the access ticket is created by the browser, and acts in proxy between the service consumer and service provider for allowing the service consumer to access the particular functionalities of the service provider granted by the service provider.

Step 412: The access ticket specifying the particular functionalities on the service provider that are permitted to be accessed is sent to the service consumer that requested the ticket. In some implementations, an access ticket is a native object in the browser's execution context on the client computer. The exposed functionalities that are allowed to be accessed by the service consumer are specified in the access ticket, which can, for example, be accessed by JavaScript® with support of the browser of the client computer.

Step 414: Through a granted ticket, the service consumer is able to access the specified accessible functionalities provided by the service provider. In some implementations, the specified access functionalities are referenced functionalities in the access ticket. In this case, the service consumer accesses a specified accessible functionality in the access ticket by invoking the access ticket's referenced functionality, and the access ticket then delegates the invocation to the service providing web application. Only the specified functionalities can be accessed. Those exposed functionalities that are not specified in the access ticket cannot be invoked, i.e., accessed. Since an access ticket is a native object that cannot be created directly or copied by JavaScript®, a web application cannot pass its access ticket to another web application, or create a valid access ticket to access another web application's exposed functionalities.

Step 416: In general, when the service provider receives a request for access to one or more exposed functionalities, the service provider checks that such an access is allowed as specified in a valid access ticket included in the request. In some implementations, such a checking and transferring of an access ticket when accessing to one or more exposed functionalities are not needed, resulting in more efficient access. This is done by using a native object as an access ticket, and the allowed exposed functionalities are referenced in the tickets that can be invoked by JavaScript®. When an exposed functionality in the access ticket is invoked by the service consumer, the access ticket delegates the invocation to the access-ticket-issuing service provider, which then executes its corresponding logic in the service provider's context to provide a service to the invoker (i.e., the service consumer). The execution result is then delegated back to the service consumer via the access ticket. Note that an access ticket is a native object and only those functionalities referenced in the access ticket can be invoked, i.e., accessed. Those exposed functionalities that are not referenced in the access ticket cannot be invoked, i.e., accessed. This invoking approach does not require a service provider to check if a web application has the right to access its exposed functionality or functionalities. If the requested one or more functionalities are specified, i.e., referenced, in the access ticket included with the request, then the service provider allows the service consumer access to the one or more functionalities.

Step 418: The conditions of the service provider and/or the service consumer may be monitored by the browser. The access ticket may be automatically expired when any one of the associated communication pair (i.e., the service provider and/or the service consumer) reaches the end of its lifecycle. In implementations including the lifecycle declarations 132, the access ticket expires when the lifecycle of the service provider expires or when the lifecycle of the service consumer expires. Further, as discussed above, a particular lifecycle declaration may be applied to a particular access ticket. For example, the service provider may provide a first lifecycle declaration for the functionality specified in a first access ticket, but may also have a global lifecycle declaration based upon a different lifecycle. Other methods for determining expiration of the communication pair may also be implemented so that the access ticket may automatically expire as soon as either peer in the relationship expires.

The access ticket mechanism provides the following advantages in terms of security and convenience. (1) Since a web application always accesses functionalities of another application through an access ticket, and the access ticket expires at the end of the lifecycle of the service provider, a service consumer never sends any message to an incorrect service provider. Therefore the service consumer is protected from CWCP attacks. (2) Further, because an access ticket is a native object that cannot be created directly or copied by JavaScript®, an access ticket cannot be used by any web application other than the ticket requester. Therefore, the service provider, i.e., the ticket granter, can ensure that every service consumer has to acquire a ticket before invoking any of the service provider's functionalities. Accordingly, the service provider is also protected from CWCP attacks. (3) Additionally, for each access ticket, the access control logic is executed only once when the service provider handles the ticket request. Since only the granted functionalities of the service provider are able to be accessed through the access ticket, checking of access rights is not needed in later rounds of interaction between the service provider and the service consumer. Accordingly, it may be seen that the foregoing provides a very efficient access control scheme.

### Implementations Applied to SCDC Schemes

Implementations of the defensive mechanisms described above may be applied to the proposed SCDC schemes discussed previously, such as CompoWeb, HTML5 and MashupOS. For instance, CompoWeb adopts a component-oriented web architecture to build web mashups, and includes several unique features. For example, web applications may be isolated by default even if they come from the same domain. Therefore, implementations of the defense mechanisms disclosed herein, when implemented with CompoWeb, are not affected by SOP, which grants fully accessibility between applications from the same domain. Furthermore, in CompoWeb, each web application can expose a set of APIs in the form of member methods, properties and events. These structured APIs can be furthermore grouped by publicly declared interfaces. Accordingly, the access control implementations disclosed herein can be easily integrated with the granularity of publicly declared interfaces.

In CompoWeb, a web component called a “gadget” is able to invoke another gadget in the same manner as if invoking a normal JavaScript® object, i.e., through the latter gadget's exposed member properties, methods, and events. CompoWeb allows a developer to declare an abstraction of contract-based channels (i.e., gadget interfaces). A gadget could choose to implement multiple interfaces by implementing the functionalities defined in the interface specification files. Thus, a gadget can be considered a specialized service provided by a web application, and some gadgets provide mashup type functionality by incorporating into themselves other gadgets, information, or other services provided by other web applications.

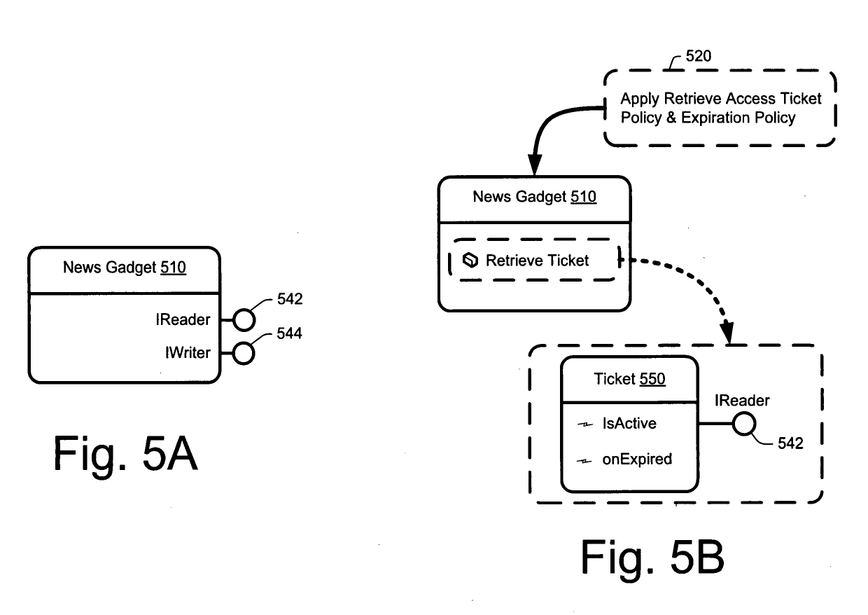

FIG. 5A illustrates an example gadget 510 named “News Gadget”, which periodically fetches and displays the recent news from other sources, such as from other web applications. This news gadget 510 has implemented two interfaces 542, 544, named “IReader” and “IWriter” respectively, where “IReader” abstracts the logic of fetching news data from remote other gadgets or applications on other servers, and “IWriter” abstracts the logic of outputting the gathered news, such as to the end user's computer.

The following is an example of script that may be used to invoke an API named “ReadAll” exposed by the news gadget:
var allNews=newsGadgetId.ReadAll( );
   where “newsGadgetId” is the name of the gadget and “ReadAll” is the API. Like an HTML window in HTML5, a gadget in CompoWeb can load different web applications dynamically at different times. CompoWeb also may use the name of the web component to reference a web application. As a result, CompoWeb is also vulnerable to CWCP attacks like other SCDC schemes.

As illustrated in FIG. 5B, several modifications may be made to the CompoWeb communication model based on implementations described herein. First, a web application developer can specify the lifecycle and the access control rules for each web application and gadget. The lifecycle declaration for each web application can be defined in XML format, as described above, or in other suitable format. The access control rules can also be defined in XML. Each access control rule specifies what kind of functionalities can be exposed to what kind of communication peers. For instance, it is possible to specify the access control of “granting full access” to those gadgets from the self domain (which will be referred to as “self.com” in this example) and granting interface IReader 542 access to those gadgets from other domains. The following is an example of XML script which may be used for specifying such access control:

<AccessControlRules>
<add origin=“self.com” grantedInterfaces=“*” />
<add origin=
“*”grantedInterfaces=“http://gadgetInterfaces.com/IReader.xml;” />
</AccessControlRules>

In some implementations herein, instead of directly invoking the news gadget, a web application has to acquire an access ticket from the news gadget 510 by using the one of the gadget's member methods, which is named “RetrieveTicket” in this example. The “RetrieveTicket” is a pre-defined member method added to every web gadget in CompoWeb by our proposal. Thus, as illustrated in FIG. 5B, retrieve access ticket policy & expiration policy 520 is applied to gadget 510. As described above with respect to the exemplary process of FIG. 4, the gadget checks the caller's identity against the specified access control rules and returns an access ticket object 550 to the caller.

For instance, in the illustrated example of FIG. 5B, news gadget 510 receives a request for an access ticket 550 from a web application that requests access to the IReader functionality 542. After verifying the identity of the ticket requester, as discussed above with respect to the process of FIG. 4, news gadget 510 determines whether to grant access to this functionality for this requester. Access control rules may be consulted by news gadget 510 for determining whether a particular requester should have access to particular functionalities. These access control rules may be tailored for each application and specific access requesters. If access is granted, then a ticket 550 is returned to requester for use when accessing the IReader functionality 542. Lifecycle declarations may also be provided and used in these implementations to determine when the access ticket 550 expires. Through this access ticket object 550, a web application as a service consumer is able to access the permitted functionalities exposed by the news gadget 510 and granted by the access control rules. The ticket object may expire when the news gadget expires. In implementations with a lifecycle declaration from the new gadget, the expiration condition of the news gadget is specified by the lifecycle declaration, such as through a lifecycle declaration XML file. An exemplary script to access news gadget 510 may be as follows:

var ticket = newsGadgetId.RetrieveTicket( );
if (ticket.IsActive) {
var allNews = ticket.readAll( );
...
}
ticket.onExpired = ... //respond the ticket expiration event

Additionally, in those SCDC schemes which still partially adopt the SOP, such as HTML5 and MashupOS, web applications from the same domain are mutually fully trusted, which can enable some of the implementations disclosed herein to be bypassed. Accordingly, implementations disclosed above, in the case of SOP, are arranged so that each web application is placed in a different domain so that there no fully trusted relationship exists between any two web components.

From the foregoing, it will be apparent that implementations disclosed herein provide defense mechanisms to address the vulnerabilities caused by dynamic web mashups. Some implementations provide for defense mechanisms that enable a web application developer to explicitly specify the lifecycle of a web application through a lifecycle declaration, so that a browser can automatically monitor the lifecycle of the web application by detecting changes that take place with respect to web applications in dynamic web mashups, and then respond accordingly. Some implementations provide for defense mechanisms that enforce accessibility to a web application through the use of access tickets. An access ticket has to be acquired before accessing a web application's exposed functionalities. A first web application can select a subset of exposed functionalities to grant access rights to another web application. Only the exposed functionalities specified in the access ticket can be accessed, and the access ticket is bound to the ticket requester/holder and cannot be transferred to other web applications.

Implementations also relate to a system and apparatus for performing the operations described herein. This system and apparatus may be specially constructed for the required purposes, or may include one or more general-purpose computers selectively activated or reconfigured by one or more programs when the program instructions are executed. Such programs may be stored in one or more processor-readable storage mediums as instructions executed by one or more processors to perform steps of the implementations described herein. The one or more processor-readable storage mediums may include, but are not limited to, optical disks, magnetic disks, read-only memories, random access memories, solid-state devices and drives, or any other type of medium suitable for storing electronic information, and may be located at a location remote from the one or more processors executing the one or more programs.

Some implementations are described in the context of computer-executable instructions, such as program modules, and executed by one or more computers or other processing devices. Generally, program modules include routines, programs, objects, components, data structures, and the like, that perform particular tasks or implement particular functions. Typically the functionality of the program modules may be combined or distributed as desired in various implementations. In addition, implementations are not necessarily described with reference to any particular programming language. It will be appreciated that a variety of programming languages may be used to implement the teachings described herein. Further, it should be noted that the system configurations illustrated in FIGS. 1 and 2A are purely exemplary of systems in which the implementations may be provided, and the implementations are not limited to a particular hardware configuration. In the description, numerous details are set forth for purposes of explanation in order to provide a thorough understanding of the disclosure. However, it will be apparent to one skilled in the art that not all of these specific details are required.

Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims. Additionally, those of ordinary skill in the art appreciate that any arrangement that is calculated to achieve the same purpose may be substituted for the specific implementations disclosed. This disclosure is intended to cover any and all adaptations or variations of the disclosed implementations, and it is to be understood that the terms used in the following claims should not be construed to limit this patent to the specific implementations disclosed in the specification. Rather, the scope of this patent is to be determined entirely by the following claims, along with the full range of equivalents to which such claims are entitled.

1. A computer-implemented method implemented by one or more processors executing processor-executable instructions stored in one or more processor-accessible mediums, and carried out for securing communications in a web mashup, the method comprising:
receiving an access ticket request from a service consumer, said access ticket request for receiving permission for accessing one or more functionalities of a service provider;
verifying an identity of the service consumer;
issuing an access ticket that specifies one or more functionalities of the service provider that the service consumer is permitted to access; and
providing access to the one or more functionalities specified in the access ticket to the service consumer.

2. The method according to claim 1, further comprising:
checking the access ticket for determining the functionalities that the service consumer is permitted to access prior to granting the access request.

3. The method according to claim 1, further comprising:
monitoring conditions of the service provider and/or service consumer; and
expiring the access ticket when the monitored conditions indicate that at least one of the service provider and service consumer is expired.

4. The method according to claim 1, further comprising:
providing a lifecycle declaration by at least one of the service consumer and the service provider; and
expiring the access ticket when a lifecycle of at least one of the service consumer and the service provider expires based on the lifecycle declaration.

5. The method according to claim 4, wherein providing the lifecycle declaration comprises that the lifecycle expires upon the occurrence of an event selected from a group comprising:
the service provider or the service consumer making the lifecycle declaration navigates to a different uniform resource locator;
the service provider or the service consumer making the lifecycle declaration carries out a page refresh; or
the service provider or the service consumer making the lifecycle declaration runs script able to retrieve content dynamically.

6. The method according to claim 4, further comprising:
providing a ticket lifecycle declaration by the service provider, wherein the ticket lifecycle declaration specifies a ticket lifecycle different from a global lifecycle specified in a global lifecycle declaration provided by the service provider; and
expiring the ticket when either the ticket lifecycle or the global lifecycle expires.

7. The method according to claim 1, further comprising:
the access ticket is a native object and the accessible functionalities specified by the access ticket are referenced in the native object.

8. The method according to claim 7, further comprising:
creating the access ticket by a browser upon the request by the service provider,
wherein the service provider can only let a browser generate access tickets for specifying functionalities of the service provider that can be accessed by service consumers, and cannot let a browser generate access tickets to access the other functionalities of the service provider or the functionalities of other web applications.

9. The method according to claim 7, further comprising:
invoking, by the service consumer, one of the functionalities specified in the access ticket to access the functionality;
checking by the browser whether the invoked functionality is specified by the access ticket;
delegating the invocation to the service provider, wherein the service provider does not need to check if the service consumer has permission to access the invoked functionality.

10. The method according to claim 1, further comprising:
providing a first web application as the service provider and a second web application as the service consumer, said first web application running on a first server and said second web application running on a second server.

11. One or more processor-accessible storage mediums containing processor-executable instructions implemented by one or more processors for carrying out the method of claim 1.

12. A system for securing communications in a web mashup, the system comprising:
a processor;
a memory coupled to the processor,
wherein the processor is configured to receive a lifecycle declaration provided by one of a first application or a second application for securing communications between the first application and the second application,
wherein the first application provides a service and the second application consumes the service in the web mashup, and
wherein the processor is configured to monitor the first application or second application which provided the lifecycle declaration, and terminate communication between the first application and the second application when a lifecycle of the first application or the second application has expired, as determined from the lifecycle declaration.

13. The system according to claim 12,
wherein the lifecycle declaration comprises that the lifecycle expires when the first application or second application which provided the lifecycle declaration navigates to a different uniform resource locator.

14. The system according to claim 12,
wherein the lifecycle declaration comprises that the lifecycle expires when the first application or second application which provided the lifecycle declaration carries out a page refresh.

15. The system according to claim 12,
wherein the lifecycle declaration comprises that the lifecycle expires when the first application or second application which provided the lifecycle declaration runs script able to retrieve content dynamically.

16. The system according to claim 12, further comprising:
a computer comprising the processor including a web browser executed by the processor;
wherein the web browser is configured to monitor conditions of the first application or second application which provided the lifecycle declaration to determine when the lifecycle expires; and
wherein the web browser is configured to notify the first application or the second application when the lifecycle of the other of the first application or the second application expires to provide notification that communications between the first application and the second application terminate.

17. The system according to claim 12,
wherein the processor is further configured to issue an access ticket issued by the first application to the second application, and
wherein the processor is configured to refer to the access ticket when the second application requests access to functionalities of the first application, wherein the access ticket specifies which functionalities of the first application that the second application is permitted to access.

18. The system according to claim 17, further comprising
wherein the processor is configured to expire the access ticket when the lifecycle of the first application or the second application which provided the lifecycle declaration is determined to have ended based upon the lifecycle declaration.

19. The system according to claim 12,
wherein both the first application and the second application provide respective lifecycle declarations to the processor when establishing communications in the web mashup.

20. One or more processor-accessible storage media containing processor-executable instructions, implemented by one or more processors, for performing acts comprising:
accessing a web mashup aggregating a first application providing service and a second application consuming a service, wherein the first application as a service provider receives a ticket request from the second application as a service consumer, said ticket request being for receiving permission for accessing one or more functionalities of the first application;
receiving a lifecycle declaration from the first application for securing communications between the first application and the second application;
creating an access ticket by the browser upon a request by the first application, wherein the access ticket specifies functionalities of the first application that the second application is permitted to access, wherein the second application invokes the access ticket for accessing the one or more functionalities of the first application in the web mashup;
monitoring, by the browser, conditions of the first application to determine when the lifecycle expires; and
expiring the access ticket and notifying the second application when the lifecycle of the first application expires so that the second application is aware that the access ticket has expired.
